(19) United States
(12) Patent Application Publication
(10) Pub. No.: US 2013/0009099 A1
(43) Pub. Date: Jan. 10, 2013

(54) Process For The Production Of Hydrogen/Carbon Monoxide

(75) Inventor: Bhadra S. Grover, Sugar Land, TX (US)

(73) Assignee: L'Air Liquide Societe Anonyme Pour L'Etude Et L'Exploitation Des Procedes Georges Claude, Paris (FR)

(21) Appl. No.: 13/176,439

(22) Filed: Jul. 5, 2011

(51) Int. Cl. C01B 3/50

(52) U.S. Cl. 252/373

(57) ABSTRACT

The present invention provides for an energy efficient process of producing hydrogen/carbon monoxide gas mixtures from one or more hydrocarbon gas streams treated in a syngas producing unit by utilizing a carbon dioxide removal unit that contains sorbent beds in which a magnesium based sorbent is transported and cycled between different beds for sorption and desorption of carbon dioxide. The carbon dioxide recovered during the process is recovered at high temperature and high pressure therefore allowing for at least a portion of the carbon dioxide stream to be recycled for further treatment with little or no compression of the stream.

### FIELD OF THE INVENTION

The present invention relates to an energy efficient process for recovering and recycling a high pressure and high temperature carbon dioxide stream during hydrogen/carbon monoxide production by utilizing sorbent beds configured to allow for the use of a magnesium based sorbent that is transported and cycled to different sorption beds for the sorption and desorption of carbon dioxide.

### BACKGROUND

There exists a variety of known processes for the production of hydrogen/carbon monoxide gas mixtures from hydrocarbon feed streams such as natural gas utilizing a steam hydrocarbon reformer unit. As a result of the steam hydrocarbon reformer treatment, a mixture that includes at least hydrogen, carbon monoxide and carbon dioxide results. Since the intent is to produce a hydrogen/carbon monoxide gas mixture, the carbon dioxide present must be removed from the mixture produced in the steam hydrocarbon reformer, and recycled for conversion to carbon monoxide. A number of different processes for carbon dioxide removal from the gas mixture have been proposed over the years but most result in a low pressure/low temperature carbon dioxide stream. For example, solvent scrubbing processes such as the amine scrubbing process have been used to remove the carbon dioxide present in hydrogen/carbon monoxide production processes but the amine process requires gas cooling to a temperature from about 40° C. to about 70° C. thereby resulting in a loss of thermal efficiency and a carbon dioxide product that is at low pressure/low temperature.

In the typical prior art steps for the production of hydrogen/carbon monoxide, a hydrocarbon feed stream is treated in a steam hydrocarbon reformer unit to produce a syngas stream which is further treated by a system such as an amine based system to remove the carbon dioxide from the hydrogen/carbon monoxide mixture. As noted, such systems often require a reduction in temperature of the syngas stream for the carbon dioxide to be removed thereby resulting in a carbon dioxide stream that is at low temperature and low pressure. In the traditional hydrogen/carbon monoxide process, it is often desirable to recycle a portion of the carbon dioxide recovered to the steam hydrocarbon reformer unit to be further treated in order to maximize the production of carbon monoxide over hydrogen and carbon dioxide. As the carbon dioxide product stream is at low pressure/low temperature, it must be compressed to the pressure range of the hydrocarbon feed stream that is being introduced into the steam hydrocarbon reformer unit before it can be recycled. Accordingly, processes such as the one detailed above are not only capital intensive (due to the need for a compressor) but also energy intensive (due to the loss of thermal efficiency).

A variety of new sorbents have been proposed for the removal of carbon dioxide. For example, the publication “Reduction In The Cost Of Pre-combustion CO₂ Capture Through Advancements in Sorption-enhanced Water-gas-shift” by Andrew Wright, et al describes a process for carbon dioxide capture using K₂CO₃ promoted hydrotalcite. The carbon dioxide stream produced is at low pressure, and any steam in the carbon dioxide product stream is lost during cooling of the carbon dioxide stream upstream of carbon dioxide compression.

In another example, the publication “Novel Regenerable Magnesium Hydroxide Sorbent for CO₂ Capture at Warm Gas Temperatures” (Ind. Eng. Chem. Res. 2009, 48, 2135-2141; Rajani V Siriwardane and R. W Stevens of NETL; hereinafter “Novel Regenerable Magnesium Hydroxide Sorbent for CO₂ Capture”) describes a sorbent based on Mg(OH)₂ that can capture carbon dioxide at temperatures from 200° C. to 315° C. and can release carbon dioxide and be regenerated at a temperature from 375° C. to 400° C. in the presence of steam. The noted article indicates that this sorbent may be used in applications such as carbon dioxide capture from coal gasification syngas. These sorbents produce carbon dioxide streams at elevated pressure and temperature. However, it does not teach how to utilize the hot carbon dioxide and steam mixture produced during the regeneration of the sorbent. See also, U.S. Pat. No. 7,314,847.

The present invention provides a process that allows for the economical production of hydrogen/carbon monoxide gas mixtures by recycling the carbon dioxide and steam mixture at high pressure and high temperature, resulting in an overall process that is efficient from a cost and energy standpoint.

### SUMMARY OF THE INVENTION

The present invention provides an energy efficient process of producing hydrogen/carbon monoxide gas mixtures from one or more hydrocarbon gas streams treated in a syngas producing unit in which the carbon dioxide recovered during the process is recovered at high temperature and high pressure therefore allowing for at least a portion of the carbon dioxide stream to be recycled for further treatment with little or no compression of the stream. This process comprises utilizing a magnesium based sorbent in a fluidized form to capture the carbon dioxide. By incorporating such a sorbent as a part of a carbon dioxide recovery unit into the process, it is possible to provide carbon dioxide at a pressure high enough to be able to mix the carbon dioxide with the hydrocarbon feed supplied to the syngas producing unit. More specifically, by subjecting the syngas stream produced from the syngas producing unit to treatment in a carbon dioxide recovery unit that contains sorbent beds with each sorbent bed configured to allow for the use of such a magnesium based sorbent, it is possible to obtain a high pressure/high temperature carbon dioxide stream that can be recycled to the syngas producing unit for further treatment while minimizing, if not eliminating, the need to compress the carbon dioxide stream and to also offset the quantity of steam that needs to be injected for the syngas producing unit by the amount of steam present in the hot carbon dioxide stream.

### BRIEF DESCRIPTION OF THE FIGURES

FIG. 1 provides a schematic of the process of the present invention which includes a purge phase.

FIG. 2 provides a schematic of the process of the present invention which does not include a purge phase.

### DETAILED DESCRIPTION OF THE INVENTION

The process of the present invention provides for the incorporation of a sorbent based carbon dioxide removal unit into a process for the production of hydrogen/carbon monoxide gas mixtures. By utilizing a solid sorbent based carbon dioxide removal unit in which the sorbent is transported and cycled to different beds for sorption and desorption of carbon dioxide, it is possible to effectively remove the carbon dioxide present from the syngas stream produced in the syngas producing unit (especially steam hydrocarbon reformer units) thereby producing a hydrogen/carbon monoxide mixture as well as a high pressure/high temperature carbon dioxide stream that can be recycled to the syngas producing unit for use as a supplemental feed while minimizing the need for compression of this stream. As used herein, the phrase “high pressure and high temperature” with regard to the resulting carbon dioxide stream refers to a carbon dioxide stream at a pressure from about 10 bar to about 30 bar and a temperature from about 375° C. to about 420° C. The sorbent in the bed is kept fluidized or moving to be able to transport it from one bed to another bed.

The process of the present invention involves producing a hydrogen/carbon monoxide gas stream and a high purity carbon dioxide stream from one or more hydrocarbon feed streams utilizing a syngas producing unit in combination with a carbon dioxide removal unit comprising one or more sorbent beds in which a magnesium based sorbent is transported and cycled between different beds for sorption and desorption of carbon dioxide. As used herein, the phrase “high purity carbon dioxide” refers to a carbon dioxide stream that contains greater than 90% carbon dioxide, preferably greater than 95% carbon dioxide and even more preferably, greater than 99% carbon dioxide.

More specifically, the present process provides for two main embodiments: one embodiment that contains four phases, including a purge phase, and another embodiment that contains three phases, with no purge phase being necessary. With regard to the first embodiment, the process involves introducing one or more hydrocarbon feed streams into a syngas producing unit to generate a syngas stream, subjecting the syngas stream to treatment in a carbon dioxide removal unit containing at least four sorbents beds (with at least one sorbent bed corresponding to each phase of carbon dioxide removal utilizing the noted sorbent) to produce a hydrogen/carbon monoxide gaseous stream, a purge effluent gas and a high temperature/high pressure carbon dioxide rich stream, recycling the purge effluent gas to the hydrocarbon feed stream as a supplemental feed, recycling at least a portion of the carbon dioxide rich stream to the hydrocarbon feed stream as a supplemental feed to increase the production of carbon monoxide with regard to hydrogen in the hydrogen/carbon monoxide gaseous stream, and withdrawing the remaining portion of the carbon dioxide rich stream, if any, as product. With regard to the second embodiment, the general process is basically the same with the exception that there is no purge phase. Accordingly, only a hydrogen/carbon monoxide gaseous stream and a high temperature/high pressure carbon dioxide rich stream are produced with at least a portion of the carbon dioxide rich stream being recycled to the hydrocarbon feed stream as a supplemental feed, and the remaining portion of the carbon dioxide rich stream, if any, being utilized as product.

Note that in the embodiment where a purge phase is included, the sorbent is purged with steam to remove any gases such as hydrogen, carbon monoxide, and methane that are entrained with the sorbent from the first sorbent bed. This increases the purity of carbon dioxide being recovered in the next step. When the purity of the carbon dioxide product is not of great concern or when all of the carbon dioxide recovered is to be recycled, it is not necessary to include the purge phase as in the second embodiment.

With regard to each embodiment of the present process, the hydrogen/carbon monoxide gaseous stream that is withdrawn may be further treated to separate a high purity hydrogen stream or high purity carbon monoxide from the hydrogen/carbon monoxide gaseous stream. Those of ordinary skill in the art will recognize that the hydrogen/carbon monoxide gaseous stream may also contain residual amounts of carbon dioxide as well as the other components that may be present in the original gas stream treated. As used herein, the phrase “residual amounts” when referring to the amounts of other components that may be present in the hydrogen/carbon monoxide gaseous stream refers collectively an amount that is less than about 5.0%, preferably less than about 3.0% and even more preferably less than about 1.0%.

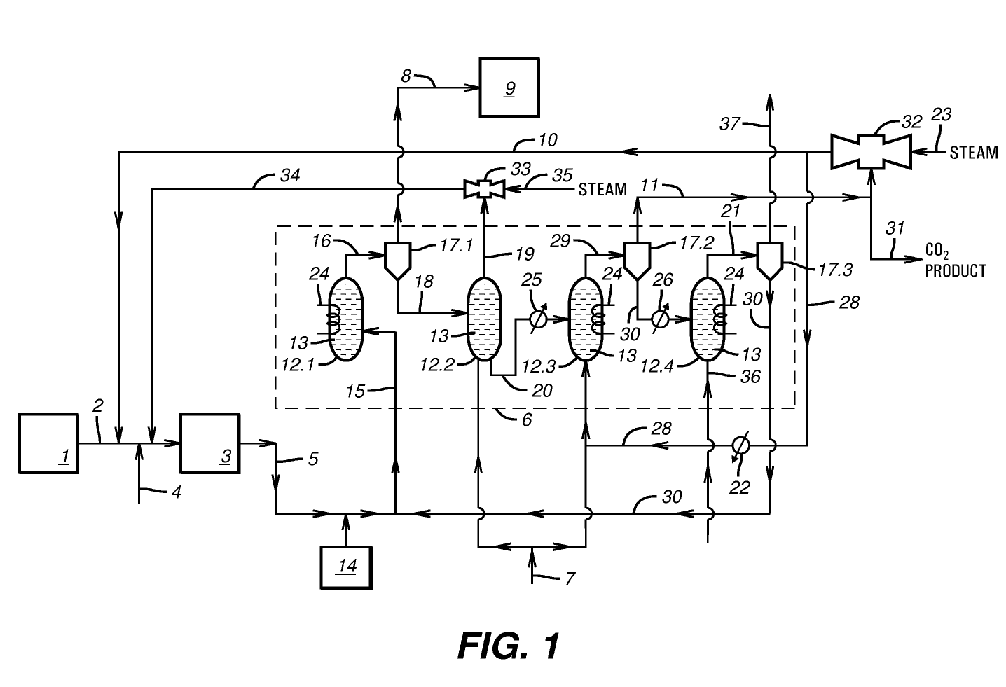

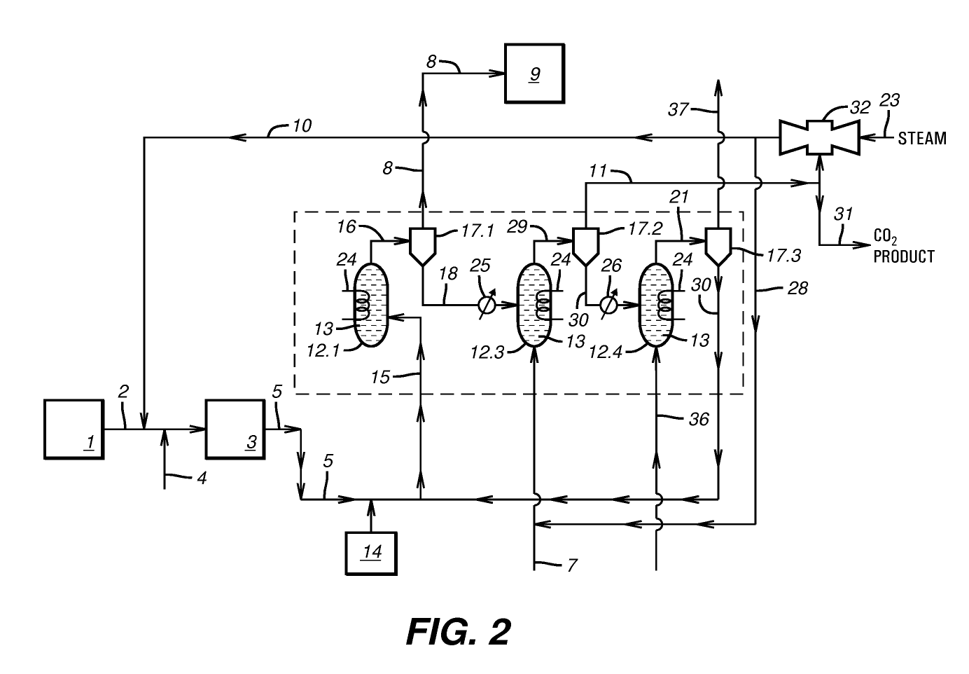

The present process will be further described with reference to the figures contained herein (FIG. 1 and FIG. 2), each figure corresponding to one embodiment of the present process. Note that these figures are not meant to be limiting with regard to the present process and are included simply for non-limiting illustrative purposes.

The first embodiment of the present invention provides for a process as shown in FIG. 1 which includes a carbon dioxide removal unit 6 which includes a purge phase (sorbent bed 12.2). With further reference to FIG. 1, the process involves the generation of a syngas stream by the treatment of one or more hydrocarbon feed streams (preferably natural gas) provided from a source 1 via line 2 in a syngas producing unit 3. With regard to this particular embodiment, the syngas producing unit 3 may be a steam hydrocarbon reformer unit, an autothermal reformer unit or a partial oxidation unit. Steam hydrocarbon reforming, autothermal reforming and partial oxidation and the conditions under which each of these occurs are known to those skilled in the art and accordingly will not be discussed herein in specific detail. Accordingly, the present invention is not meant to be limited by the type of syngas producing unit 3 used or the conditions under which the syngas producing unit 3 is operated. For purposes of simplicity, the process of the present invention will be discussed furthermore with regard to a steam hydrocarbon reforming unit which will be referenced as “3”.

Those skilled in the art will recognize that the pressure at which steam hydrocarbon reforming is carried out will depend upon the actual process being utilized. For example, in some instances, the pressure can be as low as 5 bar. Generally though, the steam hydrocarbon reforming takes place at a pressure that ranges from about 10 bar to about 40 bar, more typically from about 10 to about 30 bar. The one or more hydrocarbon feed streams are introduced via line 2 into the steam hydrocarbon reformer unit 3 where the reforming of the feed streams takes place. When needed, steam is added to the hydrocarbon feed streams via line 4. The reaction product from the steam hydrocarbon reformer unit 3 (syngas producing unit) is principally a syngas stream that contains at least hydrogen, carbon monoxide, methane, water vapor and carbon dioxide in proportions close to equilibrium amounts at elevated temperature and pressure (hereinafter collectively referred to as “syngas stream”).

In the second step of the process of the present embodiment, the syngas stream 5 obtained from the steam hydrocarbon reformer unit 3 (or the partial oxidation unit or autothermal reformer unit as the case may be) is subjected to carbon dioxide removal in a carbon dioxide removal unit 6 in order to obtain a hydrogen/carbon monoxide gas mixture. Those skilled in the art recognize that the syngas stream 5 from the reformer unit 3 will likely need to be cooled (not shown) before it is sent for carbon dioxide removal. In addition, those skilled in the art recognize that there are many ways to recover the heat/cool from the syngas stream. Accordingly, when necessary, the syngas stream that is obtained from the steam hydrocarbon reformer unit 3 via line 5 is cooled and then in the third step of the process subjected to treatment in a carbon dioxide removal unit 6 that contains at least four sorbent beds 12 (individually labeled as 12.1, 12.2, 12.3, and 12.4), that are configured to allow for the use of a magnesium based sorbent 13 with each of the sorbent beds 12 corresponding to a different phase in the first embodiment of the present process for the removal of the carbon dioxide from the syngas stream utilizing the loose sorbent 13.

The sorbent 13 that is utilized in the process of the present invention is highly selective for carbon dioxide and is selected from magnesium based sorbents, more particularly magnesium hydroxide sorbents. The sorbent 13 in this fluidized/moving bed process is typically found in the form of small beads, granules, or crumbs of the sorbent 13 that are small enough in size to allow for these forms to be easily fluidized. Of these sorbents 13, the most preferred with regard to the present process are the magnesium hydroxide sorbent such as those disclosed in U.S. Pat. No. 7,314,847 and Novel Regenerable Magnesium Hydroxide Sorbent for CO₂ Capture, the full contents of each incorporated herein.

The magnesium based sorbent utilized in the process of the present invention is in a moving/fluidized form. Those skilled in the art of moving/fluidized beds will recognize that fluidization requires the gas stream to lift and move the solids, and special separators to separate the gas from the solids. Similarly, moving beds require moving grates, conveyors, etc. Such various manners of fluidization are well known to those skilled in the art therefore details are not included herein. The ability to move the sorbent around makes it a continuous and steady state process, as compared to a batch process for fixed beds.

Those skilled in the art will recognize that the present process may be carried out using any number of sorbent beds 12 provided that at least one bed 12 corresponds to each phase of the process and that flow between such beds 12 can be controlled by any means known in the art such as through strategically placed lines and valves. In one preferred embodiment of the present process as set forth in FIG. 1, the schematic configuration utilized with regard to the carbon dioxide removal unit 6 is a configuration that contains at least four sorbent beds 12 with at least one sorbent bed 12 utilized in each phase of the process.

The sorbent 13 passes through the series of sorbent beds 12 which correspond to the various phases of carbon dioxide removal within the carbon dioxide removal system: the sorption phase (sorbent bed 12.1), the purge phase (sorbent bed 12.2), the carbon dioxide release phase (sorbent bed 12.3) and the rehydroxylation phase (sorbent bed 12.4). With regard to the example set forth in FIG. 1, the syngas from line 5 is typically injected into the first sorbent bed 12.1 along with a supply of sorbent 13 via line 15. Note the method of conveying sorbent by gas is well known to those familiar with the art, and is not discussed or shown herein. Similarly, separation of gas from sorbent, shown as 17.1, 17.2, and 17.3 in FIG. 1 is well known to those familiar with the art.

As noted, the treatment of the syngas stream in the sorbent beds 12 involves four phases: a sorption phase, a purge phase, a carbon dioxide release phrase and a sorbent rehydroxylation phase. The first of these phases, the sorption phase, involves introducing the syngas stream via line 5 into the first sorbent bed 12.1 in the carbon dioxide removal unit 6 along with the magnesium based sorbent 13 obtained from the sorbent source 14 or recycled from 12.4 (discussed further herein). As the sorbent 13/syngas stream pass through the first sorbent bed 12.1, the carbon dioxide in the syngas stream selectively reacts with the sorbent 13 resulting in the production of a mixture comprising reacted sorbent and a hydrogen/carbon monoxide gaseous rich syngas stream. As the syngas and reacted sorbent 13 pass through the fluidized sorbent bed 12.1, the components of the syngas (mainly carbon dioxide) that react with the sorbent 13 are retained on (affixed to) the sorbent 13.

Note that the residence time of sorbent in the first sorbent bed 12.1 will depend upon the particular sorbent 13 utilized. As used herein, with regard to the sorption phase, the term “capacity” and phrase “high capacity” each refer to the amount of carbon dioxide that the sorbent 13 will remove from the syngas stream. More specifically, the term “capacity” and phrase “high capacity” each refer to the amount of reactive sites (hydroxyl sites) of the sorbent 13 that react with carbon dioxide.

The balance of the unreacted syngas along with reacted sorbent 13 exits the sorbent bed 12.1 via line 16 and is then passed to a phase separator 17.1 where unreacted syngas is separated from the reacted sorbent 13. The unreacted syngas stream comprises both hydrogen and carbon monoxide in high concentrations and is essentially carbon dioxide free. As used herein, the phrase “essentially carbon dioxide free” refers to a stream that contains less than about 1.0% carbon dioxide, preferably less than about 0.5% carbon dioxide and even more preferably, less than about 0.1% carbon dioxide. However, as noted before, those skilled in the art will recognize that these essentially carbon dioxide free unreacted syngas streams often contain residual amounts of other components that may be present in the original syngas stream to be treated as well.

Note that the temperature at which the syngas stream is introduced into the sorbent bed 12.1 will depend upon the specific sorbent 13 utilized as well as the conditions under which the reforming reaction is carried out. Typically, the syngas stream will be introduced into the first sorbent bed 12.1 at a temperature that ranges from about 100° C. to about 315° C. and at a pressure that ranges from about 10 bar to about 40 bar, preferably at a temperature that ranges from about 180° C. to about 300° C. and at a pressure from about 20 bar to about 40 bar.

With regard to the actual chemical reaction taking place with regard to the sorbent 13, the sorbent 13 reacts with the carbon dioxide in the syngas stream to produce a carbonate and water. For example, in the case of magnesium hydroxide the reaction is:

Mg(OH)₂+CO₂→MgCO₃+H₂O

The magnesium hydroxide reacts with the carbon dioxide to yield magnesium carbonate and water. While a majority of the carbon dioxide present in the syngas stream will react with the magnesium hydroxide sorbent 13 to form a carbonate, a small amount of the carbon dioxide will remain unreacted. Generally greater than 90% of the carbon dioxide in the syngas stream will be removed from the syngas stream by the sorbent 13, preferably greater than 95% and even more preferably greater than 99%.

As noted above, the phase separator 17.1 separates the sorbent from the remaining components of the unreacted syngas stream. As used herein with regard to the sorption phase, the phrase “remaining components” refers to the hydrogen, carbon monoxide, methane, water vapor and other components as defined hereinbefore (also referred to as the hydrogen/carbon monoxide gaseous stream). In addition, unreacted syngas stream may also include a small amount of the carbon dioxide that does not react with the sorbent 13. The unreacted syngas stream is sent via line 8 to the hydrogen/carbon monoxide separation unit 9 for further treatment.

The next phase in the carbon dioxide removal unit 6 is the purging of the sorbent 13 in order to remove those nonspecifically entrained components. The sorbent 13 that results from separator 17.1 is introduced into a second sorbent bed 12.2 from line 18 along with high pressure superheated steam from line 7. As a result, the reacted sorbent 13 is purged of the nonspecifically trapped or filled components from the syngas stream thereby producing a purge effluent gas. As noted previously, it is desirable to include the purge phase of the process only when a high purity carbon dioxide product is desired. The amount of steam required for the purge may not be adequate to fluidize the sorbent 13 in bed 12.2 and therefore it may be preferential to use a moving bed to remove the sorbent 13 from the bottom of the bed 12.2.

During the purge phase of the process, the superheated steam injected into the second sorbent bed 12.2 serves to displace a large portion of the remaining components that are nonspecifically trapped in the sorbent 13, thereby producing a purge effluent gas (also referred to as a purge stream) which contains these dislodged components. This purge effluent gas is withdrawn from the second sorbent bed 12.2 via line 19 for example through a reversible flow conduit (not shown) and passed on to a thermo-compressor 33. The purge effluent gas is then recycled via line 34 along with the superheated steam injected via line 35 into the thermo-compressor 33 to the hydrocarbon reformer unit 3. Accordingly, the thermal energy in hot purge effluent gas is utilized in the steam hydrocarbon reforming step. This purge effluent gas which contains hydrogen, carbon monoxide and methane is used as a supplemental feed to maximize the production of hydrogen and carbon monoxide. Note that once the purge effluent gas is separated from the purged sorbent 13, the purged sorbent 13 is then passed to the third sorbent bed 12.3 via line 20 for the next phase of treatment in the carbon dioxide removal unit 6—the carbon dioxide release phase.

In the third phase of treatment, the carbon dioxide is released from the sorbent 13 in the third sorbent bed 12.3 producing a high purity carbon dioxide stream that is also at high pressure and high temperature. This is accomplished by increasing the temperature of the purged sorbent 13 in a first heat exchanger 25 and within the third sorbent bed 12.3. A portion of the carbon dioxide recycle stream via line 28 can be added along with steam via line 7 to provide additional gas flow required for fluidization of the sorbent bed 12.3. The increase in temperature of the third sorbent bed 12.3 may be achieved in three ways or combinations thereof. The temperature of the superheated steam stream provided via line 7 can be increased, the temperature of the recycle carbon dioxide provided via line 28 can be increased through the use of a third heat exchanger 27, and/or by additional heating means such as an indirect heat exchanger 24 may be used to increase the temperature of the purged sorbent 13 in the third sorbent bed 12.3 from about 180° C. to about 315° C. to from about 350° C. to about 420° C. In each of these cases, the increase in temperature is to allow for the release of carbon dioxide from the sorbent 13 thereby producing a carbon dioxide stream that is not only hot but also wet. The pressure within the third sorbent bed 12.3 at this point is generally slightly below the pressure in the second phase (the second sorbent bed 12.2).

The mixture of sorbent 13 and the carbon dioxide gas steam is then passed along via line 29 to a second phase separator 17.2 where the carbon dioxide gas is separated from the sorbent 13. The carbon dioxide gas stream is then routed for use as product or recycled back to the reformer 3 via line 11. The sorbent 13 is passed along line 30 to a final and fourth sorbent bed 12.4 for the rehydroxylation of the sorbent 13 to take place. More specifically, with regard to the sorbent 13, the carbon dioxide is released from the carbonate formed in the sorption phase and MgO is formed which is sent to the fourth sorbent bed 12.4 for rehydroxylation to take place. In line with the previous example, this is demonstrated by the reactions as follows:

MgCO₃→MgO+CO₂

MgO+H₂O→Mg(OH)₂

As shown in this example, during the release portion of this phase, the magnesium carbonate is subjected to the noted temperatures (from about 350° C. to about 420° C.) to yield magnesium oxide and carbon dioxide.

Within the fourth sorbent bed 12.4, the sorbent is subjected to a reduced temperature to allow for the rehydroxylation. More specifically, the temperature is from about 200° C. to about 300° C. in order to allow for the rehydroxylation of the sorbent 13. During rehydroxylation, the sorbent 13 in the sorbent bed 12.4 is being contacted with the steam and/or any other moisture containing stream supplied via line 36. The sorbent may be cooled indirectly in a heat exchanger 26 upstream of sorbent bed 12.4.

During the rehydroxylation portion of this phase, magnesium oxide reacts (via hydroxylation) with water present in the steam or other moisture containing stream to yield magnesium hydroxide (a regenerated sorbent). The mixture of steam and/or any other moisture containing stream and the rehydroxylated sorbent 13 is withdrawn from the fourth sorbent bed 12.4 via line 21 and passed to the third phase separator 17.3 where they are separated and the rehydroxylated sorbent 13 is recycled via line 30 to line 15 where it can be reutilized to treat the syngas stream being injected into the first sorbent bed 12.1. The remaining steam and/or other moisture containing stream is withdrawn via line 37 and either condensed or used elsewhere.

The carbon dioxide stream produced can be utilized in two manners. First, as noted above, all or a portion of the carbon dioxide stream can be recycled via line 10 to be used as a supplemental feed to the hydrocarbon feed stream provided in line 2 to the steam hydrocarbon reformer unit 3 (or in the other embodiments to the autothermal reformer unit or the partial oxidation unit). Note that prior to the carbon dioxide stream being recycled to the steam hydrocarbon reformer unit 3, the pressure of carbon dioxide may need to be raised by a thermo-compressor 22 which is supplied with additional high pressure steam via line 23. This thermo-compressor is utilized as the pressure of the carbon dioxide during release may not being sufficient to be recycled back to the steam hydrocarbon reformer unit 3. The thermo-compressor uses from 20 to 60 bar high pressure steam as motive force. The motive steam supplied via line 23 ends up being used for the reforming of hydrocarbons in the steam hydrocarbon reformer 3. Thus, the motive steam provides mechanical energy to increase pressure of the carbon dioxide stream and water vapors for steam reforming. Those skilled in the art will recognize the limitations of the thermo-compressors 22 in terms of available pressure rise.

The purpose of providing a portion of the carbon dioxide stream back to the steam hydrocarbon reformer unit 3 is to allow for the maximization of the production of carbon monoxide—one of the desired products in the process. In addition, as steam is used to release the carbon dioxide, any steam present in the carbon dioxide will also help in off setting the amount of steam that needs to be added via line 4 for reforming. The remaining portion of the carbon dioxide stream, if any, can be utilized as carbon dioxide product as this stream is of high purity. This carbon dioxide product stream can be withdrawn for further use via line 31.

As noted above, the hydrogen/carbon monoxide gaseous stream obtained in the first phase (the sorption phase) may be withdrawn and used as product or routed for further treated in the hydrogen/carbon monoxide separation unit 9. When the hydrogen/carbon monoxide gaseous stream is further treated, it may be further treated in either a hydrogen pressure swing adsorption unit, a membrane unit or a cryogenic purification unit, or any combination of these units in order to remove the hydrogen present as a hydrogen product stream. Accordingly, it is possible to produce a high purity hydrogen stream with the remainder forming a high purity carbon monoxide stream.

A still further embodiment of the present invention involves modifying the carbon dioxide removal unit 6 to allow for the recovery of the heat of sorption and the heat of rehydroxylation in the sorbent beds 12.1 and 12.4 in order to either generate high pressure steam or hot heat transfer media and the use of this heat in sorbent bed 12.3 for the release of carbon dioxide. The steam and the hot heat transfer media can be utilized within the carbon dioxide removal unit 6 or in the steam hydrocarbon reformer unit 3. The modified carbon dioxide removal unit 6 would therefore comprise at least four sorbent beds 12.1, 12.2, 12.3 and 12.4 containing sorbent 13 and a series of heat transfer surfaces 24 that run through at least beds 12.1 (the sorption phase), 12.3 (the carbon dioxide release phase), and 12.4 (the rehydroxylation phase). The heat transfer surfaces would each have a media running there through to adsorb the heat of sorption or the heat of rehydroxylation, and provide heat for carbon dioxide release. More specifically, the heated transfer media would be used to exchange heat between the carbon dioxide removal unit 6 and various process streams of the steam hydrocarbon reformer 3, or generate high pressure steam for the carbon dioxide removal unit 6. A variety of different types of heat transfer media are available to be utilized in this manner. Examples of such heat transfer media include, but are not limited to, a molten carbonate salt mixture or any inorganic or organic compound with a boiling point that ranges from about 250° C. to about 350° C.

The second embodiment of the present process as shown in FIG. 2 is similar in nature to the first embodiment with the exception that this embodiment only contains three phases, since no purge phase being necessary. Accordingly, only a hydrogen/carbon monoxide gaseous stream and a high temperature/high pressure carbon dioxide rich stream are produced with at least a portion of the carbon dioxide rich stream being recycled to the hydrocarbon feed stream as a supplemental feed, and the remaining portion of the carbon dioxide rich stream, if any, being utilized as product. With regard to this particular embodiment, as the sorbent is not purged, there will likely be residual components in the carbon dioxide product stream as these residual components are not removed prior to the release of the carbon dioxide from the reacted sorbent 13. More specifically, with reference to FIG. 2, the process of the present invention involves the generation of a syngas stream by the treatment of one or more hydrocarbon feed streams (preferably natural gas) provided from a source 1 via line 2 in a syngas producing unit 3 as described hereinbefore with regard to the first embodiment. As with the first embodiment, for purposes of simplicity, this embodiment will also be discussed furthermore with regard to a steam hydrocarbon reforming unit which will be referenced as “3”.

As described hereinbefore, the one or more hydrocarbon feed streams are introduced via line 2 into the steam hydrocarbon reformer unit 3 where the reforming of the feed streams takes place. When needed, steam can be added to the hydrocarbon feed streams via line 4. The reaction product from the steam hydrocarbon reformer unit 3 (syngas producing unit) is principally a syngas stream as defined hereinbefore.

In the second step of the process of this second embodiment, the syngas stream 5 obtained from the steam hydrocarbon reformer unit 3 (or the partial oxidation unit or autothermal reformer unit as the case may be) is subjected to carbon dioxide removal in a carbon dioxide removal unit 6 in order to obtain a hydrogen/carbon monoxide gas mixture. When necessary, the syngas stream that is obtained from the steam hydrocarbon reformer unit 3 via line 5 is cooled and then in the third step of the process of the second embodiment, subjected to treatment in a carbon dioxide removal unit 6 that contains at least three sorbent beds 12 (individually labeled as 12.1 (the first sorbent bed), 12.3 (the second sorbent bed), and 12.4 (the third sorbent bed)), that are configured to allow for the use of the magnesium based sorbent 13 described hereinbefore in a loose form with each of the sorbent beds 12 corresponding to a different phase in the second embodiment of the present process.

As noted before, the magnesium based sorbent utilized in the process of the present invention is in a fluidized or moving form. This movement or fluidization can be carried out in the same manner as noted with regard to the first embodiment.

The sorbent 13, regardless of how it is fluidized (via gravity, conveyor belt or the injection of gas/air), is not fixed within a particular sorbent bed 12 but instead passes through the series of sorbent beds 12 which correspond to the various phases of carbon dioxide removal within the carbon dioxide removal system. Note that the method of conveying sorbent by gas is well known to those familiar with the art, and is not discussed or shown here. Similarly, separation of gas from sorbent, shown as 17.1, 17.2, and 17.3 in FIG. 2 is well known to those familiar with the art.

The actual treatment of the syngas stream in the sorbent beds 12 with regard to the second embodiment involves three phases: a sorption phase, a carbon dioxide release phrase and a sorbent rehydroxylation phase. The first of these phases, the sorption phase, involves introducing the syngas stream via line 5 into the first sorbent bed 12.1 in the carbon dioxide removal unit 6 along with the magnesium based sorbent 13 obtained from the sorbent source 14 or recycled from 12.4 (discussed further herein). The sorbent 13 and syngas stream are injected into the first sorbent bed 12.1 and allowed to pass through the first sorbent bed by any of the means discussed hereinbefore. As the sorbent 13/syngas stream pass through the first sorbent bed 12.1, the carbon dioxide in the syngas stream selectively reacts with the sorbent 13. In addition, nonspecifically filled or entrained components may also become associated with the reacted sorbent 13. The carbon dioxide and a portion of the remaining components of the syngas stream that are entrained with the sorbent result in the production of a mixture comprising reacted sorbent and a hydrogen/carbon monoxide gaseous rich stream as the syngas stream and sorbent pass through the first sorbent bed 12.1. As the syngas and reacted sorbent 13 pass through the fluidized sorbent bed 12.1, the components of the syngas (mainly carbon dioxide) that react with the sorbent 13 are retained on (affixed to) the sorbent 13. Typically, the syngas stream will be introduced into the first sorbent bed 12.1 at a temperature that ranges from about 100° C. to about 315° C. and at a pressure that ranges from about 10 bar to about 40 bar, preferably at a temperature that ranges from about 180° C. to about 300° C. and at a pressure from about 20 bar to about 40 bar.

The balance of the unreacted syngas along with reacted sorbent 13 exits the sorbent bed 12.1 via line 16 and is then passed to a phase separator 17.1 where unreacted syngas is separated from the reacted sorbent 13. The unreacted syngas stream comprises both hydrogen and carbon monoxide in high concentrations and is essentially carbon dioxide free (also referred to as hydrogen/carbon monoxide gaseous stream). The phase separator 17.1 separates the sorbent from the remaining components of the unreacted syngas stream 8, this unreacted syngas being withdrawn via line 8.

The next phase in the treatment of the syngas stream in the carbon dioxide removal unit 6 is the carbon dioxide removal phase. The sorbent 13 that results from separator 17.1 is introduced into the next sorbent bed 12.3 from line 18 along with high pressure superheated steam from line 7. As a result, the carbon dioxide is separated from the sorbent 13 in this sorbent bed 12.3. The carbon dioxide release phase of treatment in the carbon dioxide removal unit 6 provides a high purity carbon dioxide stream that is also at high pressure and high temperature. This is accomplished by having an increasing the temperature of the purged sorbent 13 in a first heat exchanger 25 and within the sorbent bed 12.3. A portion of the carbon dioxide recycle stream may be streamed via line 28 back to line 7 where this carbon dioxide can be added along with steam to provide additional gas flow required for fluidization of the sorbent bed 12.3. The increase in temperature in this sorbent bed 12.3 may be achieved in three ways or combinations thereof as described hereinbefore. In order to release the carbon dioxide, it is necessary to increase the temperature of the bed and therefore the sorbent 13 to from about 350° C. to about 420° C. This increase in temperature allows for the release of carbon dioxide from the sorbent 13 thereby producing a carbon dioxide stream that is not only hot but also wet.

The mixture of sorbent 13 and the carbon dioxide gas steam is then passed along via line 29 to a second phase separator 17.2 where the carbon dioxide gas is separated from the sorbent 13. The carbon dioxide gas stream is then routed for use as product or recycled back to the reformer 3 via line 11. As there is no purge in this particular embodiment, this schematic is likely used in processes where the carbon dioxide stream is always recycled back for further use to the reformer 3. However, in those instances where a very high degree (95% or above) of carbon dioxide purity is not necessary, this carbon dioxide stream may also be used as product. The sorbent 13 is passed along line 30 to a final sorbent bed 12.4 for the rehydroxylation of the sorbent 13 to take place as described hereinbefore. Within sorbent bed 12.4, the sorbent is subjected to a reduced temperature to allow for the rehydroxylation. More specifically, the temperature is decreased to from about 200° C. to about 300° C. During rehydroxylation, the sorbent 13 in the sorbent bed 12.4 is being contacted with steam and/or any other moisture containing stream supplied via line 36. The sorbent may be cooled indirectly in a heat exchanger 26 upstream of sorbent bed 12.4. The rehydroxylated sorbent 13 is withdrawn from phase separator 17.3 via line 30 and recycled to line 15 where it can be reutilized to treat the syngas stream being injected into the first sorbent bed 12.1.

The carbon dioxide stream and the hydrogen/carbon monoxide gaseous stream can all be further treated/used in the same manner as discussed with regard to the first embodiment. In addition, the carbon dioxide removal unit 6 of this embodiment can also be modified to allow for supplying heat for carbon dioxide release to sorbent bed 12.3, and the recovery of the heat of sorption and the heat of rehydroxylation in the sorbent beds 12.1 and 12.4 by using heat transfer media in the same manner as discussed above.

### ELEMENTS OF THE FIGURES

1—hydrocarbon feed stream source
2—line that provides hydrocarbon feed steams to steam hydrocarbon reformer unit
3—steam hydrocarbon reformer unit
4—line that provides steam to be added to the hydrocarbon feed streams
5—line that provides syngas streams from the steam hydrocarbon reformer unit to the carbon dioxide removal unit
6—carbon dioxide removal unit
7—line through which the high pressure superheated steam is introduced into the carbon dioxide removal unit
8—line through which the hydrogen/carbon monoxide gaseous stream is recycled to the rehydroxylation phase sorbent bed
9—hydrogen/carbon monoxide separation unit
10—line by which carbon dioxide purified stream is recycled to the line that provides hydrocarbon feed steams to steam hydrocarbon reformer unit
11—line by which the high pressure carbon dioxide purified stream is withdrawn
12—sorbent beds
12.1—first sorbent bed
12.2—second sorbent bed
12.3—third sorbent bed
12.4—fourth sorbent bed
13—sorbent
14—original source of sorbent
15—line through which the sorbent/syngas are passed into the first sorbent bed
16—line through which the reacted sorbent/syngas passes after the sorption phase
17.1—first phase separator
17.2—second phase separator
17.3—third phase separator
18—line through which the reacted sorbent is passed into the second sorbent bed
19—line through which the purge gas leaves the second sorbent bed
20—line through which the purged sorbent is passed into the third sorbent bed
21—line for the transport of the rehydroxylated sorbent and moisture and/or other moisture containing stream to the third phase separator
22—thermo-compressor (ejector)
23—line to inject steam into the thermo-compressor 22
24—heat transfer surfaces
25—first heat exchanger
26—second heat exchanger
27—third heat exchanger
28—line to recycle carbon dioxide to the third sorbent bed
29—line through which the carbon dioxide depleted sorbent/carbon dioxide gas passes to the second phase separator after the carbon dioxide removal phase
30—line through which the rehydroxylated sorbent is recycled to line 15 to be added back to the first sorbent bed
31—line for withdrawing carbon dioxide product
32—line to transport the hydrogen/carbon monoxide gaseous stream for further treated in the hydrogen/carbon monoxide separation unit
33—thermo-compressor (ejector)
34—line to transport purge stream for recycle to the reformer
35—line to inject steam into the thermo-compressor 33
36—line to supply steam and/or other moisture containing stream to the fourth sorbent bed
37 line to withdraw the remaining steam and/or other moisture containing stream from the third phase separator

1. A process for recovering and recycling a high pressure and high temperature carbon dioxide stream during hydrogen/carbon monoxide production from one or more hydrocarbon feed streams, said process comprising:
a) introducing one or more hydrocarbon feed streams into a syngas producing unit to generate a syngas stream that contains hydrogen, carbon monoxide, carbon dioxide, methane and water vapor;
b) treating the syngas stream in a carbon dioxide removal unit that contains at least a first sorbent bed, a second sorbent bed, a third sorbent bed and a fourth sorbent bed, the first, second, third and fourth sorbent beds being connected in series and being configured to allow for the passage of a gas and a magnesium based sorbent that is highly selective for carbon dioxide through the series of sorbent beds, the treatment involving:
i) a sorption phase in which the syngas stream and the magnesium based sorbent are introduced into the first sorbent bed at a temperature from about 100° C. to about 315° C. and a pressure from about 10 to about 40 bar, the carbon dioxide in the syngas stream selectively reacting with the sorbent and a portion of the remaining components of the syngas stream nonspecifically reacting with the sorbent to produce a mixture comprising reacted sorbent and a hydrogen/carbon monoxide gaseous rich stream as the syngas stream and sorbent pass through the first sorbent bed,
ii) a first separation in which the mixture comprising reacted sorbent and a hydrogen/carbon monoxide gaseous rich stream pass from the first sorbent bed and through a first phase separator to separate the reacted sorbent from the hydrogen/carbon monoxide gaseous rich stream,
iii) a purge phase in which the reacted sorbent and a high pressure superheated steam are each introduced into a second sorbent bed in order to purge the reacted sorbent of the nonspecifically trapped components from the syngas stream thereby producing a mixture of purged sorbent which is withdrawn from a bottom of the second sorbent bed and a purge effluent gas which is withdrawn from a top of the second sorbent bed;
iv) a carbon dioxide release phase in which the purged sorbent is introduced into the third sorbent bed along with superheated steam, the superheated steam used along with indirect heat to raise the temperature of the third sorbent bed to of between 350° C. and 420° C. thereby allowing for the release of the carbon dioxide from the purged sorbent to produce a carbon dioxide deficient sorbent and a wet, high temperature carbon dioxide rich stream;
v) a second separation in which the carbon dioxide deficient sorbent and the carbon dioxide rich stream are passed from the third sorbent bed and through a second phase separator to separate the carbon dioxide deficient sorbent and a carbon dioxide product stream;
vi) a rehydroxylation phase in which the carbon dioxide deficient sorbent is introduced into the fourth sorbent bed where the temperature is lowered to about 200° C. to 300° C. and the carbon dioxide deficient sorbent is contacted with steam and/or a moisture containing stream to allow for the rehydroxylation of the sorbent,
vii) a third separation in which the rehydroxylated sorbent and the steam and/or a moisture containing stream are passed from the fourth sorbent bed and through a third phase separator to separate the steam and/or a moisture containing stream from the rehydroxylated sorbent;
c) recycling the rehydroxylated sorbent to the first sorbent bed;
d) recycling at least a portion of the wet high temperature, high pressure carbon dioxide rich stream to the hydrocarbon feed stream that is to be introduced into the syngas producing unit to increase the production of carbon monoxide and withdrawing any remaining portion of the high temperature, high pressure carbon dioxide rich stream as carbon dioxide product for further use; and
e) recycling the purge effluent gas along with the high pressure superheated steam to the hydrocarbon feed stream that is to be introduced into the syngas producing unit.

2. The process of claim 1, wherein the syngas producing unit is selected from a steam hydrocarbon reformer unit, an autothermal reformer unit, and a partial oxidation unit.

3. The process of claim 2, wherein the syngas producing unit is a steam methane reformer unit.

4. The process of claim 2, wherein the sorbent is passed through a heat exchanger prior to being introduced into the third sorbent bed in order to raise the temperature of the sorbent.

5. The process of claim 2, wherein the sorbent is passed through a heat exchanger prior to being introduced into the fourth sorbent bed in order to lower the temperature of the sorbent.

6. The process of claim 2, wherein a portion of the hot carbon dioxide product stream is used to further fluidize the sorbent in the third sorbent bed.

7. The process of claim 2, wherein the carbon dioxide removal unit contains more than one sorbent bed corresponding to each phase of the carbon dioxide removal.

8. The process of claim 2, wherein the magnesium based sorbent used in the sorbent beds is magnesium hydroxide.

9. The process of claim 8, wherein the pressure in all sorbent beds is relatively the same.

10. The process of claim 3, wherein each of the sorbent beds includes a means for heating and cooling the sorbent beds.

11. The process of claim 10, wherein the means for heating and cooling the sorbent beds includes a series of heat transfer surfaces that run through the sorbent beds, the heat transfer surfaces having disposed therein a heated transfer media which becomes heated due to the heat generated with sorption and rehydroxylation.

12. The process of claim 11, wherein the heated transfer media is used to generate high pressure steam for the carbon dioxide removal unit or the steam methane reformer unit or as a source of heat for the reforming process.

13. The process of claim 12, wherein the heat transfer media which has recovered the heat from the process streams of the reformer is used to heat the sorbent.

14. The process of claim 12, wherein heat transfer media which has recovered the heat from the process streams of the reformer is used to cool the sorbent.

15. The process of claim 12, wherein the heated transfer media is molten carbonate salt mixture.

16. The process of claim 12, wherein the heated transfer media is an inorganic or organic compound with a boiling point that ranges about 250° C. to about 350° C.

17. The process of claim 1, wherein the magnesium based sorbent used in the sorbent beds is magnesium hydroxide.

18. The process of claim 1, wherein the hydrogen/carbon monoxide gaseous stream is further treated to separate the hydrogen from the carbon monoxide using a hydrogen/carbon monoxide separation unit selected from a hydrogen pressure swing adsorption unit, a membrane unit or a cryogenic purification unit, or a combination of these to produce high purity hydrogen and high purity carbon monoxide.

19. The process of claim 3, wherein prior to a portion of the wet high temperature, high pressure carbon dioxide rich stream being recycled to the hydrocarbon feed stream to be introduced into the steam hydrocarbon reformer unit, the carbon dioxide rich stream is passed through a thermo-compressor while high pressure steam is introduced.

20. A process for recovering and recycling a high pressure and high temperature carbon dioxide stream during hydrogen/carbon monoxide production from one or more hydrocarbon feed streams, said process comprising:
a) introducing one or more hydrocarbon feed streams into a syngas producing unit to generate a syngas stream that contains hydrogen, carbon monoxide, carbon dioxide, methane and water vapor;
b) treating the syngas stream in a carbon dioxide removal unit that contains at least a first sorbent bed, a second sorbent bed, and a third sorbent bed, the first, second, and third sorbent beds being connected in series and being configured to allow for the passage of a gas and a magnesium based sorbent that is highly selective for carbon dioxide through the series of sorbent beds, the treatment involving:
i) a sorption phase in which the syngas stream and the magnesium based sorbent are introduced into the first sorbent bed at a temperature from about 100° C. to about 315° C. and a pressure from about 10 to about 40 bar, the carbon dioxide in the syngas stream selectively reacting with the sorbent to produce a mixture comprising reacted sorbent and a hydrogen/carbon monoxide gaseous rich stream as the syngas stream and sorbent pass through the first sorbent bed,
ii) a first separation in which the mixture comprising reacted sorbent and a hydrogen/carbon monoxide gaseous rich stream pass from the first sorbent bed and through a first phase separator to separate the reacted sorbent from the hydrogen/carbon monoxide gaseous rich stream,
iii) a carbon dioxide release phase in which the reacted sorbent is introduced into the second sorbent bed along with superheated steam, the superheated steam used along with indirect heat to raise the temperature of the second sorbent bed to of between 350° C. and 420° C. thereby allowing for the release of the carbon dioxide from the reacted sorbent to produce a carbon dioxide deficient sorbent and a wet, high temperature carbon dioxide rich stream;
iv) a second separation in which the carbon dioxide deficient sorbent and the carbon dioxide rich stream are passed from the second sorbent bed and through a second phase separator to separate the carbon dioxide deficient sorbent and a carbon dioxide product stream;
v) a rehydroxylation phase in which the carbon dioxide deficient sorbent is introduced into the fourth sorbent bed where the temperature is lowered to about 200° C. to 300° C. and contacted with steam and/or a moisture containing stream to allow for the rehydroxylation of the sorbent,
vii) a third separation in which the rehydroxylated sorbent and the steam and/or a moisture containing stream are passed from the fourth sorbent bed and through a third phase separator to separate the steam and/or a moisture containing stream from the rehydroxylated sorbent;
c) recycling the rehydroxylated sorbent to the first sorbent bed; and
d) recycling at least a portion of the wet high temperature carbon dioxide rich stream to the hydrocarbon feed stream that is to be introduced into the syngas producing unit to maximize the production of carbon monoxide and withdrawing any remaining portion of the high temperature, high pressure carbon dioxide rich stream as carbon dioxide product for further use.

21. The process of claim 20, wherein the syngas producing unit is selected from a steam hydrocarbon reformer unit, an autothermal reformer unit, and a partial oxidation unit.

22. The process of claim 21, wherein the syngas producing unit is a steam methane reformer unit.

23. The process of claim 21, wherein the sorbent is passed through a heat exchanger prior to being introduced into the third sorbent bed in order to raise the temperature of the sorbent.

24. The process of claim 21, wherein the sorbent is passed through a heat exchanger prior to being introduced into the fourth sorbent bed in order to lower the temperature of the sorbent.

25. The process of claim 21, wherein a portion of the hot carbon dioxide product stream is used to further fluidize the sorbent in the third sorbent bed.

26. The process of claim 21, wherein the carbon dioxide removal unit contains more than one sorbent bed corresponding to each phase of the carbon dioxide removal.

27. The process of claim 21, wherein the magnesium based sorbent used in the one or more sorbent beds is magnesium hydroxide.

28. The process of claim 27, wherein the pressure in all sorbent beds is relatively the same.

29. The process of claim 22, wherein each of the sorbent beds includes a means for heating and cooling the beds.

30. The process of claim 29, wherein the means for heating and cooling the sorbent bed includes a series of heat transfer surfaces that run through the sorbent beds, the heat transfer surfaces having disposed therein a heated transfer media which becomes heated due to the heat generated with sorption and rehydroxylation.

31. The process of claim 30, wherein the heated transfer media is used to generate high pressure steam for the carbon dioxide removal unit or the steam hydrocarbon reformer or as a source of heat for the reforming process.

32. The process of claim 31, wherein the heated transfer media is molten carbonate salt mixture.

33. The process of claim 31, wherein the heated transfer media is an inorganic or organic compound with a boiling point that ranges about 250° C. to about 350° C.

34. The process of claim 20, wherein the magnesium based sorbent used in the one or more sorbent beds is magnesium hydroxide.

35. The process of claim 20, wherein the hydrogen/carbon monoxide gaseous stream is further treated to separate the hydrogen from the carbon monoxide using a hydrogen/carbon monoxide separation unit selected from a hydrogen pressure swing adsorption unit, a membrane unit or a cryogenic purification unit, or a combination of these to produce high purity hydrogen and high purity carbon monoxide.

36. The process of claim 20, wherein prior to a portion of the wet high temperature, high pressure carbon dioxide rich stream being recycled to the hydrocarbon feed stream to be introduced into the steam hydrocarbon reformer unit, the carbon dioxide rich stream is passed through a thermo-compressor for recompression using high pressure steam as the motive.
